(19) United States
(12) Patent Application Publication
(10) Pub. No.: US 2016/0006276 A1
(43) Pub. Date: Jan. 7, 2016

(54) APPARATUS AND METHOD FOR STATE OF CHARGE COMPENSATION OF AN ENERGY STORAGE SYSTEM

(71) Applicant: SIEMENS AKTIENGESELLSCHAFT, Munchen (DE)

(72) Inventors: DRAGAN MIKULEC, Erlangen (DE); TIMUR WERNER, Erlangen (DE); WOLFGANG WEYDANZ, Buckenhof (DE)

(73) Assignee: SIEMENS AKTIENGESELLSCHAFT, Munchen (DE)

(21) Appl. No.: 14/790,185

(22) Filed: Jul. 2, 2015

(30) Foreign Application Priority Data
Jul. 3, 2014 (DE) 102014212934.6

(51) Int. Cl. H02J 7/00; H02J 1/16

(52) U.S. Cl. CPC H02J 7/0014; H02J 1/16

(57) ABSTRACT

An apparatus for state of charge compensation includes at least two energy storage modules, each energy storage module having an energy storage module voltage, at least two voltage converter modules, with each voltage converter module being electrically connected to a respective one of the at least two energy storage modules in one-to-one correspondence and forming a corresponding submodule, an electrical machine electrically connected to the at least two submodules, and a control device configured to control a flow of electrical energy between at least one of the submodules and the electrical machine.

### CROSS-REFERENCES TO RELATED APPLICATIONS

This application claims the priority of German Patent Application, Serial No. 10 2014 212 934.6, filed Jul. 3, 2014, pursuant to 35 U.S.C. 119(a)-(d), the content of which is incorporated herein by reference in its entirety as if fully set forth herein.

### BACKGROUND OF THE INVENTION

The present invention relates to an apparatus for state of charge compensation and to a method for state of charge compensation.

The following discussion of related art is provided to assist the reader in understanding the advantages of the invention, and is not to be construed as an admission that this related art is prior art to this invention.

To supply power to electrical components, electrical energy/power storage devices are generally provided. Such energy/power storage devices can be, for example, battery cells which provide a battery cell voltage, or capacitors. In order to provide a desired voltage level, the battery cells are normally interconnected to form battery stacks. In low-voltage applications, voltages of less than 60 V are usually provided, in high-voltage applications, voltages of more than 60 V, in particular of more than 100 V, are usually provided. Energy storage devices in high-voltage applications can be designed, for example, to power electrical machines, e.g. electric motors in vehicles.

Particularly for high-voltage applications, the voltage of single battery stacks is generally insufficient. To achieve a higher voltage, in particular a voltage in the high-voltage range, it can be provided that a plurality of battery stacks is used to supply an electrical component, e.g. an electric motor. For this purpose a plurality of battery stacks are usually connected in series to form a battery system to which an electrical component to be supplied is connected. The sum of the voltages of the individual battery stacks is therefore available to the electrical component.

Because of possible different aging effects, manufacturing tolerances and loading profiles or even different battery cell chemicals, the battery stacks may exhibit differing charge states and different impedances. As a result, the series-connected battery stacks are discharged and charged differently during operation, in which case they may assume critical charge states. The different charge states are generally compensated using so-called state of charge compensation or balancing methods. Without appropriate balancing, service-life-extending and full utilization of the entire installed battery energy is impossible, or it would be necessary to accept an operating strategy that would limit a possible operating range of the battery system.

In the prior art, so-called dissipative balancing methods are currently mainly used. Here the battery stack or battery cell having the highest state of charge is discharged by converting the charging energy of said battery stack or battery cell into heat by means of a parallel-connected resistor. The excess energy of the more heavily charged battery stack or battery cell is therefore reduced via losses in ohmic balancing resistors. This balancing process is generally monitored by a battery management system.

These dissipative methods are generally energy-inefficient and involve high costs due to the complex monitoring by the battery management system. Another disadvantage is that the selective discharging of the cells via ohmic resistors produces waste heat which cannot be efficiently used in all operating points. In addition, in some cases this is not possible in every operating state.

It would therefore be desirable and advantageous to obviate prior art shortcomings and to provide an energy-efficient and inexpensive apparatus and a method for state of charge compensation with which a battery system can be used more effectively and its service-life can be extended.

### SUMMARY OF THE INVENTION

According to one aspect of the present invention, an apparatus for state of charge compensation includes at least two energy storage modules, each energy storage module having an energy storage module voltage, at least two voltage converter modules, with each voltage converter module being electrically connected to a respective one of the at least two energy storage modules in one-to-one correspondence and forming a corresponding submodule, an electrical machine electrically connected to the at least two submodules, and a control device configured to control a flow of electrical energy between at least one of the submodules and the electrical machine.

The apparatus according to the invention is used for state of charge compensation. In particular, the apparatus is used for selective monitoring of the state of charge.

In other words this means that an energy/power storage module, e.g. a battery stack and/or a capacitor, is connected to a voltage converter module to form a submodule in each case. In each submodule, the energy storage module provides an energy storage module voltage which is applied to the connected voltage converter module. Each submodule therefore constitutes a separate modular voltage supply device. A single electrical machine, e.g. an electric motor, is connected to the at least two submodules. The electrical machine can have a plurality of different windings which are connected to the respective submodules.

The control device now controls the energy flow, in particular the direction of the energy flow, between at least one of the submodules and the electrical machine or more precisely a winding of the electrical machine. Accordingly, in motor mode, the electrical machine or rather a winding of the electrical machine may be supplied with energy/power which is provided by one or more of the energy storage modules of the individual submodules. Energy therefore flows from at least one of the connected submodules to the electrical machine or more specifically the winding. In generator mode, the electrical machine or winding provides energy/power which is supplied to one or more of the energy storage modules for charging the energy storage module. Energy therefore flows from the electrical machine or rather the winding of the electrical machine to at least one of the submodules. The fact that the control device monitors, controls and synchronizes the power flows means that the different battery stacks incorporating the associated voltage converter modules can be operated differently in terms of power—in both motor and generator mode. In particular, the energy storage modules can be of different design, i.e. they can be different energy storage modules which can be operated according to their characteristics. Therefore, an energy storage module can be replaced by another energy storage module having largely different characteristics and/or a different construction, for example, as long as particular system parameters such as voltage or also other safety-relevant system parameters are retained. The apparatus can therefore be designed in a particularly flexible manner. The advantage of this is that the apparatus, by uniformly distributing the energy, can be used to protect power storage devices, e.g. capacitors, from overvoltage and therefore destruction. This design also increases system reliability. Due to the fact that redundant phases can be implemented in the form of submodules, the overall system continues to be operable even if a submodule fails. This is not the case with today's systems in which the calls are connected in series, as the entire system becomes inoperable if a cell fails.

Advantageously, the control device is designed to control at least one of the submodules and/or the electrical machine such that electrical energy flows from a first of the at least two energy storage modules to the electrical machine and from the electrical machine to a second of the at least two energy storage modules. Energy can also flow from one of the at least two energy storage modules to a winding of the electrical machine and from the winding of the electrical machine to a second of the at least two energy storage modules. The electrical machine or rather at least one winding can therefore draw power from one energy storage module and supply this power or part of this power to another energy storage module. For this power flow synchronization, the software of the control device, e.g. a submodule controller, can be adapted such that, for balancing, at least some of the power supplied by one submodule can be absorbed by another submodule. This power transfer from one battery stack to another battery stack takes place with a particularly high degree of efficiency, as the excess energy of a battery stack is not dissipated in the form of heat via ohmic balancing resistors, but is fed as power to another battery stack.

According to another advantageous feature of the present invention, the electrical machine may include at least two independent three-phase windings and that one of the at least two three-phase windings is electrically connected to one of the at least two submodules in each case. In this form of embodiment the electrical machine is implemented as a three-phase motor. The three-phase motor is supplied with energy such that each of its self-contained, i.e. electrically isolated, three-phase windings is connected to a submodule in each case. The energy provided by the energy storage module of the connected submodule is therefore supplied to each three-phase winding. Thus, for example, three-phase motors can be supplied with energy in high-voltage applications.

According to another advantageous feature of the present invention, the control device may be configured to control at least one of the submodules and/or the electrical machine such that at least some electrical energy flows from the first of the submodules via a first of the at least two three-phase windings, from the first three-phase winding to a second of the at least two three-phase windings, and from the second three-phase winding to the second submodule. Here, the electrical machine is used as a three-phase transformer. No additional battery balancing system is hence necessary for this purpose. To achieve this, energy from one energy storage module can be injected into the motor via a three-phase winding of the motor and the same amount of energy can be diverted into the second energy storage module via another three-phase winding of the same motor—without an electrical connection between the energy storage modules in question. Effectively this means that the electrical energy is not converted into a mechanical form of energy, but the state of charge is equalized between two battery stacks without an additional circuit having to be used for this purpose. However, it can also be provided that only a portion of the energy removed from the first energy storage module is fed back to the second energy storage module. The remaining energy can then continue to be available for motor operation of the three-phase motor. The inherent energy storage module balancing via the motor windings, which can also be implemented for motors having more than two independent three-phase windings, also reduces the energy management system costs.

According to another advantageous feature of the present invention, the control device may be configured to control the electrical energy flow such that the electrical machine draws or feeds electrical energy from/to one energy storage module having a first energy storage module charge state and feeds or draws electrical energy to/from an energy storage module having a second battery module charge state different from the first battery module charge state in accordance with a predetermined operating strategy. For example, the control device can therefore control the energy flow such that, for balancing, energy flows from a more heavily charged energy storage module to a more weakly charged energy storage module so that the states of charge are equalized. The energy flow direction can be specified, for example, via a predetermined operating strategy.

In one exemplary embodiment, the apparatus may include a switching device disposed between the two energy storage modules for electrically connecting the energy storage modules and/or for electrically isolating the energy storage modules. Electrical connection by means of the switching device enables the energy storage modules to be connected in series to form a battery system. However, the energy storage modules and therefore the submodules can also be electrically isolated from one another by means of the switching device in the event of undesirable electrical interference between the submodules. Due to the fact that the individual energy storage modules can be electrically isolated from one another during operation, the apparatus according to the invention can be spatially arranged in a particularly flexible manner.

According to another advantageous feature of the present invention, the apparatus may include a heating device which is designed to provide the power dissipated during energy flow between the at least two submodules as heat output. This special operating case deliberately produces power dissipation in the form of waste heat by injecting power into individual submodules and removing it from other submodules at a similar level. This dissipated power is fed to a heating device. If the apparatus according to the invention is disposed in a motor vehicle, for example, wherein the submodules supply e.g. an electric motor with energy for propelling the motor vehicle, the dissipated power fed to the heating device as heating energy can be made available, for example, for heating the battery system or an interior of the motor vehicle.

According to another advantageous feature of the present invention, the control device may be configured to control at least one of the submodules and/or the electrical machine such that an amount of electrical energy for driving the electrical machine which is drawn from the energy storage module having a first energy storage module charge state is greater than that which is drawn from an energy storage module having a second energy storage module charge state that is lower than the first energy storage module charge state. In other words this means that the individual energy storage modules combined with the associated voltage converter modules are operated differently in terms of power. This can be used, among other things, to equalize different states of charge. However, it can also be used to adapt the operating conditions to different charging and ageing states in order to optimize not only the instantaneous power flow but also the ageing behavior of the battery system. In addition, the full storage capacity of all the individual energy storage modules can thus be utilized.

According to the operating strategy, a motor load demand, for example, can likewise be deliberately distributed unevenly over different submodules in order to equalize said submodules in terms of state of charge or state of ageing, or to deliberately load them unevenly, according to an operating strategy or their maximum power data or their state of ageing or other parameters. The same can be applied analogously to the charging of different submodules.

The control device is preferably designed to control at least one of the submodules and/or the electrical machine such that an amount of electrical energy drawn from the electrical machine which is fed to a battery sub-module having a first battery sub-module charge state is greater than that which is fed to a battery sub-module having a second battery sub-module charge state that is different from the first battery sub-module charge state. In other words, this means that in generator mode of the electrical machine, for example, a larger amount of energy which is provided by the electrical machine operating as a generator can be fed to one battery sub-module than to the other battery sub-module. The apparatus is therefore of particularly flexible and energy-efficient design.

The invention also relates to a method for state of charge compensation. The method involves providing at least two energy storage module voltages each representing a voltage drop across a corresponding energy storage module, connecting each of the at least two energy storage modules to a corresponding voltage converter module to form at least two submodules, connecting an electrical machine to the at least two submodules, and controlling an electrical energy flow between at least one of the at least two submodules and the electrical machine.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 schematically illustrates an exemplary embodiment of the apparatus according to the present invention; and

FIG. 2 schematically illustrates the apparatus according to the invention within a circuit topology.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

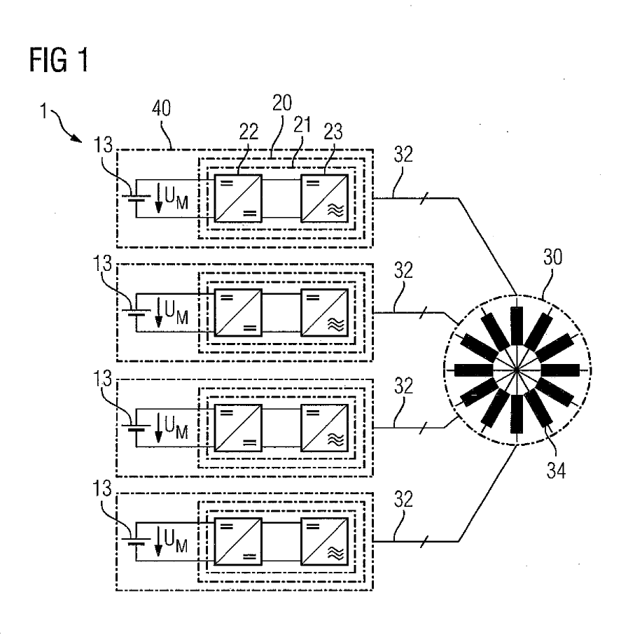

Turning now to the drawing, and in particular to FIG. 1, there is shown an apparatus 1 for state of charge compensation. The apparatus 1 has four submodules 40. Each of the submodules 40 includes an energy storage module 13 across which an energy storage module voltage U_{M} is dropped. The energy storage module voltage U_{M} is fed to a voltage converter module 20. The voltage converter module 20 comprises a voltage conversion element 21, wherein each voltage conversion element 21 has an inverter 23. The voltage conversion element 21 can also have, for example, a DC/DC converter 22. The DC/DC converter 22 can in particular be implemented as a step-up converter for converting the energy storage module voltage U_{M} provided by the energy storage module 13 to a higher voltage which is fed to the inverter 23. The inverter 23 converts the DC voltage provided by the DC/DC converter 22 to an AC voltage or more precisely 3-phase AC voltage.

All the submodules 40 presented here are each connected to an electrical machine 30 via a supply lead 32. The supply leads 32 can be implemented, for example, as three-phase lines. The electrical machine 30 can be implemented in particular as a three-phase motor having a plurality of three-phase windings 34 electrically isolated from one another. It is provided that each phase of the three-phase supply lead 32 is electrically connected to one of the three-phase windings 34. Here this means that one three-phase winding 34, which can consist of three phase windings that are electrically interconnected, is supplied by the first (top) submodule 40, another three-phase winding 34 which can consist of three phase windings is supplied by the second submodule 40, another three-phase winding 34 which can consist of three phase windings is supplied by the third submodule 40, and the remaining three-phase winding 34 which can consist of three phase windings is supplied by the fourth (bottom) submodule 40. Due to the fact that the three-phase windings 34 are electrically isolated from one another, the energy storage modules 13 and therefore also the submodules 40 are also electrically isolated from one another.

In motor mode, the electrical machine 30 is therefore supplied via the supply leads 32 with energy which is provided by the energy storage modules 13 of the connected submodules 40.

If all the energy storage modules 13 are evenly loaded, ideally the states of charge of all the energy storage modules 13 are the same. However, if e.g. the state of charge of the first (top) energy storage module 13 is greater than the state of charge of the second energy storage module 13, a control device (not shown here) can be designed to initiate a process of state of charge compensation, a so-called balancing process. For this purpose the control device controls the electrical machine 30 or the submodules 40 affected such that transformer operation of the electrical machine 30 is provided. In this transformer mode, the electrical machine 30, which is implemented as a three-phase motor, is used as a three-phase transformer.

For this purpose, power in the form of a DC voltage is drawn from the first, more heavily charged energy storage module 13 of the first submodule 40. This is converted by the inverter 23 of the first submodule 40 into an AC voltage and fed via the first supply lead 32 to the connected first three-phase winding 34. During transformer operation, the first three-phase winding 34 transfers the entire AC voltage to a second three-phase winding 34. This second three-phase winding 34 which is connected to the second submodule 40 whose energy storage module 13 has the lower state of charge feeds the entire transformed AC voltage or part of the transformed AC voltage to the inverter 23 of the second submodule 40. As the inverter 23 can be operated bidirectionally, it converts the transformed AC voltage into a DC voltage which it feeds to the less heavily charged energy storage module 13 for charging. The first energy storage module 13 is therefore discharged and the second energy storage module 13 is charged. As soon as the states of charge of the two energy storage modules 13 are equalized or rather have attained a predetermined charge state, the balancing process can be terminated and the electrical machine 30 again used completely in motor mode or in generator mode.

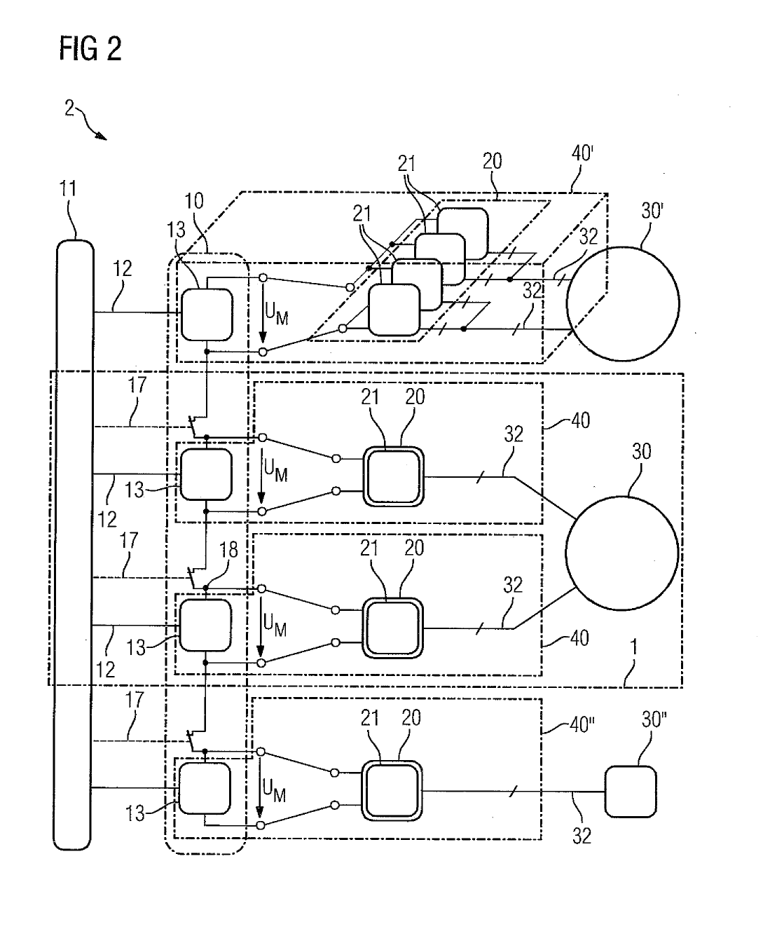

FIG. 2 shows the apparatus according to the invention 1 in a circuit topology 2. The circuit topology 2 can be, for example, a motor vehicle's high-voltage electrical system.

Here a plurality of energy storage modules 13 are connected in series via switching devices 17 to form an energy storage system 10, e.g. a battery system. The switching devices 17 can be controlled by means of a control device 11 via control buses 12. An energy storage module voltage U_{M} is dropped across each of the energy storage modules 13. Voltage taps 18 via which a voltage converter module 20 is connected to each energy storage module 13 are disposed between the individual energy storage modules 13 of the battery system 10. The energy storage module voltage U_{M} of an energy storage module 13 is now dropped across the voltage converter module 20 which is electrically connected to the energy storage module 13. An energy storage module 13 and a connected voltage converter module 20 constitute a submodule 40, 40′, 40″.

Electrical loads 30, 30′, 30″ can be supplied with energy by means of the submodules 40, 40′, 40″.

Inside the upper submodule 40′, the voltage converter module 20 comprises a plurality of parallel-connected voltage conversion elements 21 to which an electrical component 30′, in particular an electric motor, is connected via a supply lead 32. The parallel connection of the voltage conversion elements 21 within the submodule 40′ is used for current scaling.

The lower submodule 40″ supplies energy via a supply lead 32 to an electrical component 30″ which is here implemented as a DC load. The voltage conversion element 21 of the voltage converter module 20 is here implemented as a synchronous converter, for example, in particular a step-up converter.

In this exemplary embodiment, an electrical component 30 is connected to the two middle submodules 40 via supply leads 32. This connection constitutes the apparatus 1 according to the invention. The electrical component can be implemented as a three-phase motor.

When the three-phase motor 30 is operating in motor mode, the three-phase motor 30 is supplied via the supply leads 32 with energy which is provided by the energy storage modules 13 of the submodules 40. As soon as the energy storage modules 13 of the submodules 40 exhibit different charge states or deviate from charge states predefined in an operating strategy, the control device 11 controls the submodules 40 and/or the electrical machine 30 such that a balancing process is initiated. For this purpose the electrical machine 30 is used as a transformer, wherein energy is drawn from the more heavily charged energy storage module 13 and fed via the electrical machine 30 to the less heavily charged energy storage module 13 as charging energy.

While the apparatus 1 is operating in transformer mode, the other submodules 40′ and 40″ can continue to supply the connected loads 30′ and 30″ with energy.

The example illustrates an apparatus for state of charge compensation with which a balancing process can be carried out, in particular without an additional circuit.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An apparatus for state of charge compensation, comprising
at least two energy storage modules, each energy storage module having an energy storage module voltage,
at least two voltage converter modules, with each voltage converter module being electrically connected to a respective one of the at least two energy storage modules in one-to-one correspondence and forming a corresponding submodule,
an electrical machine electrically connected to the at least two submodules, and
a control device configured to control a flow of electrical energy between at least one of the submodules and the electrical machine.

2. The apparatus of claim 1, wherein the control device is configured to control at least one of the at least two submodules and the electrical machine such that the electrical energy flows from a first of the at least two energy storage modules to the electrical machine and from the electrical machine to a second of the at least two energy storage modules.

3. The apparatus of claim 1, wherein the electrical machine comprises at least two independent three-phase windings and wherein the at least two three-phase windings are electrically connected to a respective one of the at least two submodules in one-to-one correspondence.

4. The apparatus of claim 3, wherein the control device is configured to control at least one of the at least two submodules and the electrical machine such that at least a portion of the electrical energy flows from a first of the at least two submodules to a second of the at least two submodules via a first of the at least two three-phase windings and a second of the at least two three-phase windings.

5. The apparatus of claim 1, wherein the control device is configured to control the flow of electrical energy such that the electrical machine removes electrical energy from or supplies electrical energy to an energy storage module having a first energy storage module charge state and supplies or removes at least a portion of the previously removed/supplied energy to/from an energy storage module having a second energy storage module charge state that is different from the first energy storage module charge state according to a predetermined operating strategy.

6. The apparatus of claim 1, further comprising a switching device disposed between two respective energy storage modules and configured to at least one of electrically connect and isolate the energy storage modules from one another.

7. The apparatus of claim 1, further comprising a heating device configured to provide the power dissipated during energy flow between the at least two submodules as a heat output.

8. The apparatus of claim 1, wherein the control device is configured to control at least one of the at least two submodules and the electrical machine such that an amount of electrical energy removed from an energy storage module having a first energy storage module charge state for driving the electrical machine is greater than an amount of electrical energy removed from an energy storage module having a second energy storage module charge state that is lower than the first energy storage module charge state.

9. The apparatus of claim 1, wherein the control device is configured to control at least one of the at least two submodules and the electrical machine such that an amount of electrical energy removed from the electrical machine and supplied to a battery storage module having a first battery storage module charge state is greater than an amount supplied to a battery storage module having a second battery storage module charge state that is different from the first battery storage module charge state.

10. A method for state of charge compensation, comprising:
providing at least two energy storage module voltages, each representing a voltage drop across a corresponding energy storage module,
connecting each of the at least two energy storage modules to a corresponding voltage converter module to form at least two submodules,
connecting an electrical machine to the at least two submodules, and
controlling an electrical energy flow between at least one of the at least two submodules and the electrical machine.
